(19) United States
(12) Patent Application Publication
(10) Pub. No.: US 2012/0072316 A1
(43) Pub. Date: Mar. 22, 2012

(54) VIRTUAL ACCOUNTING LEDGER SYSTEM

(76) Inventor: Paul Baumann, Gettysburg, PA (US)

(21) Appl. No.: 13/222,408

(22) Filed: Aug. 31, 2011

Related U.S. Application Data
(60) Provisional application No. 61/378,744, filed on Aug. 31, 2010.

(51) Int. Cl. G06Q 40/00

(52) U.S. Cl. 705/30

(57) ABSTRACT

The present invention is directed to a virtual electronic accounting ledger and method for sharing and locating account transaction business documents among multiple users with a computer system. The accounting ledger is logically divided to correlate to audit compliance criteria and includes automatic updating of substantive data across a global computer network. Native document files may be stored in a database of the global computer network and linked to substantive data of the company.

### CROSS-REFERENCE TO RELATED APPLICATIONS

The present application claims the benefit of U.S. provisional application Ser. No. 61/378,744 titled Virtual Accounting Ledger System, filed Aug. 31, 2010 and is incorporated herein by reference in its entirety.

### FIELD OF THE INVENTION

The present invention relates to the field of document retention and more specifically to the field of computerized process account tracking

### BACKGROUND

Auditing company processes and data is a laborious task that is both complicated and eased by the implementation of instantaneous communication. Business activities occur faster than ever, and parties that were once separated by time and space find themselves capable of initiating, maintaining, and closing an activity in great detail and with great rapidity. Furthermore, auditing has become a highly specialized arena; audit standards and processes differ from trade to trade and in light of the body desiring audit compliance. One of the fastest growing areas of audit includes government audits.

The Defense Contract Audit Agency possesses one of the most organized forms of audit criteria. The DCAA audit criteria requires the auditor to obtain a sufficient understanding of the contractor's internal controls and to assess control risk to plan the audit and to determine the nature, timing, and extent of tests to be performed. The internal control activities of a company are greatly scrutinized. Internal control, as defined by SAS No. 78, is “a process effected by an entity's board of directors, management, and other personnel, designed to provide reasonable assurance regarding the achievement of objectives in the following categories: (a) reliability of financial reporting, (b) effectiveness and efficiency of operations, and (c) compliance with applicable laws and regulations.”

A contractor's internal controls consist of five interrelated components: the control environment, risk assessment, the control activities, information and communication, and monitoring. The control environment sets the tone of an organization, influencing the control consciousness of its people. The risk assessment includes the entity's identification and analysis of relevant risks to achievement of its objectives, forming a basis for determining how the risks should be managed. The control activities include the policies and procedures that help ensure that management directives are carried out. The information and communication include the identification, capture, and exchange of information in a form and time frame that enable people to carry out their responsibilities. The monitoring includes the process that assesses the quality of internal control performance over time. Each of these subjects may be weighed in any audit of a government contractor. Government contractors can expect audits with great regularity; it is simply a part of their business operations. As the DCAA contract audit manual explains:
It is DCAA's policy that each relevant accounting or management system that has a significant impact on Government contract costs be audited on a cyclical basis, (i.e., every 2-4 years) based on a documented risk assessment. If past experience is favorable and current audit risk is considered to be low, an audit may be performed on a less frequent basis (however, no less frequently than 4 years).

Therefore, there is a need for a virtual accounting ledger system having a configuration and process capable of instantaneous update of data, establishing and documenting decisions and modifications, and that provides instant compliance with existing audit standards in a manner that tracks pre-existing audit criteria such as that of the DCAA.

### SUMMARY

The present invention is directed to a virtual electronic accounting ledger and method for sharing and locating account transaction business documents among multiple users with a computer system. The accounting ledger includes a computer with storage and a computer program with multiple nodes. The nodes conform to one of multiple predefined company category subdivisions, such as company activities, company contracts, company employees, etc. The nodes act as subject-related data holders with a portion visible to a user and a portion that is electronically-readable data. The visible data, or node front descriptive data, includes nominative data, node file descriptors, and node input descriptors for the ordered input of substantive data, including substantive community data. Node back data, i.e., data electronically readable, includes the substantive data input according to the node input descriptors. A two-dimensional drop box, or other suitable substitute, permits a virtual filing cabinet for a user to drag and drop and retain record files in the node. A retained record file is visibly indicated to the user as file descriptor data.

The multiple nodes share substantive data as community substantive data such that redundant information necessary for the retention of data in other nodes does not need to be entered again. As a node is modified, updated, or otherwise accessed, the present invention may notify another user of the action, and depending on an access level of the user, may permit the user to take action in response to the modification, update, or access. User access is controlled through a user matrix that preferable includes at least a user list, user contact list, and user access level.

The present invention permits a selectable audit system compliant, high end, job cost accounting system with a business enterprise management system. It supports all company data management functions in a single integrated database. It is accessible via the internet and therefore lends itself to companies that have employees and/or facilities that are geographically separate. It may be completely integrated with word processing programs. The present invention benefits organizations that need to collect, record, and analyze costs by contract, grant, or other cost objective. Expenses and revenues may be tagged by direct cost objective or indirect service center. Indirect costs may be automatically accumulated into overhead and indirect pools and presented in the format and manner prescribed by an audit compliance system.

The present invention streamlines accounting process by providing controls to ensure that accounting information is collected, processed, and recorded in an orderly and efficient manner. This ensures both accuracy and cost savings. In addition to its attributes as an accounting system, the present invention provides tools for everyone in the company. Each functional manager and employee may utilize windows specially designed to support its needs. The integrated back end database ensures effective dissemination of information.

The present invention coordinates the work flow through the various responsible individuals alerting individuals to their actions. It permits work to proceed in a sequence specified by preventing a given step from being completed without having first completed the preceding step. It ensures that only the authorized person is able to complete each step through password protection and granting of privileges. Processes may involve more than one individual, which minimizes the potential for fraud through separation of authority. The modular structure ensures that no single process is the purview of a single individual in the company, which further minimizes the potential for fraud. It facilitates quality assurance since the work product of each step along the process is reviewed by the person receiving the product.

Rather than order the ledger system according to the normal flows of the particular company, the system of the present invention orders the ledger according to requirements of audit procedures. Indeed, the normal pathways of activities of a company are often slowly accreted over time and tend to be merely formalizations of processes begun both informally and without regard to best practices. To combat the counterintuitive nature of providing entry as logically required by audit procedures, the present invention may include a relational database that orders tasks sequentially according to preferred accounting practices in the industry.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of the process of the present invention.

FIG. 2 is a view of the ledger system of the present invention.

FIG. 3 is a view of the ledger system of the present invention.

FIG. 4 is a view of the ledger system of the present invention.

FIG. 5 is a view of the ledger system of the present invention.

FIG. 6 is a view of the ledger system of the present invention.

FIG. 7 is a view of the ledger system of the present invention.

FIG. 8 is a view of the ledger system of the present invention.

FIG. 9 is a view of the ledger system of the present invention.

FIG. 10 is a view of the ledger system of the present invention.

### DETAILED DESCRIPTION

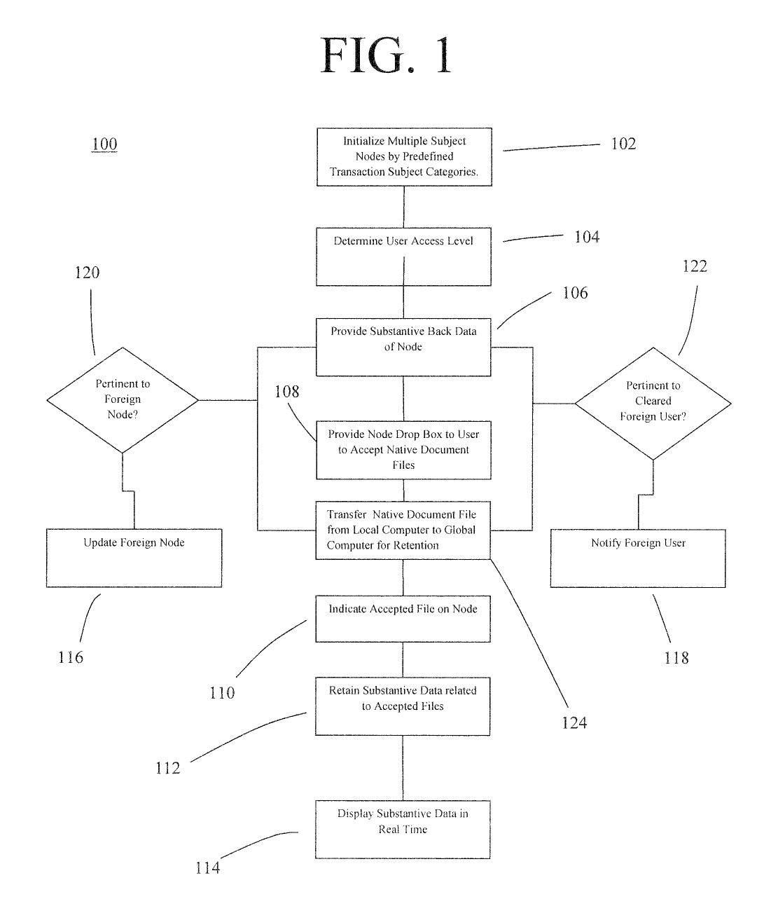

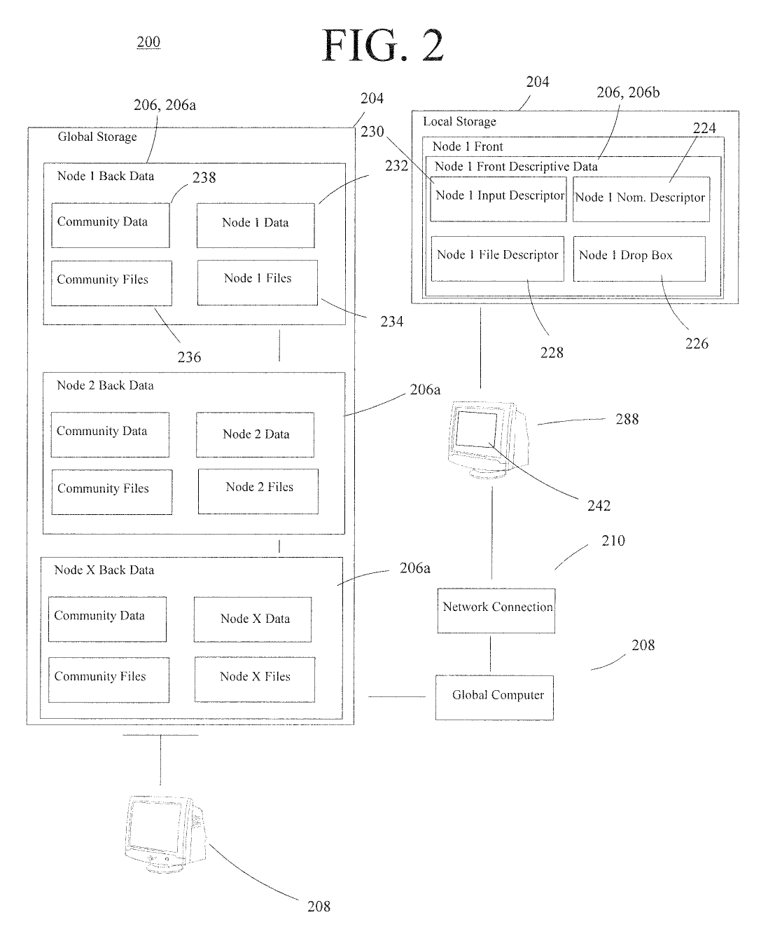

Referring first to FIGS. 1 and 2, an embodiment of a method 100 for automatic paperless maintenance of documents relating to predefined business transaction subject categories using a computer system in a virtual accounting ledger 200 is shown. The accounting ledger 200 includes an arithmetic logic unit, preferably a computer 202, with storage 204 and a computer program that displays multiple nodes 206 to a user. Each node 206 conforms to one of multiple predefined company category subdivisions. A company category division includes any subject by which a business task, business activity, or unit may be isolated. Preferred company category subdivisions include employees, employee records, company activities, company marketing, company expenses, business contracts, and the like. The nodes 206 are preferably restricted to a single subject subdivision, and more preferably the nodes correlate to predetermined audit criteria in a 1:1 ratio. By 1:1 ratio, it is meant that each audit criterion correlates to a single node, and vice versa, without non-correlating nodes or criteria. By audit criteria, it is meant any published criteria by which business records may be reviewed for conformance with predefined performance or standard elements. An example of audit criteria includes the elements of the Defense Contract Audit Agency (DCAA) Contract Audit Manual. The nodes may be arranged categorically in any fashion that, for example, permits the simplified retrieval of documents and information as correspond to the DCAA Contract Audit Manual.

In the method of the present invention, the nodes 206 are initialized 102 by subject categories by graphically portraying nodes 206 that have been allocated a particular subject matter. Initializing 102 includes presentation of a subject node 206 to a user at a local computer 288 from a global computer 208. Initialization applies whether the node is created prior to the use of the user, or whether the node is derived from subject matter created by the user to conform to creation instructions provided by the user. The user, as described herein, preferably includes a person related to the business utilizing the virtual accounting ledger 200. The user may connect to the virtual ledger 200 directly, remotely from a local computer 288, through a global computer 208 and global connection 210, or other suitable means of communication to access the global storage 204 containing the virtual ledger program 200. The global computer 208 includes any device that one or more computers may access from a location distant from the global computer. A computer may include any device capable of processing data and running programs.

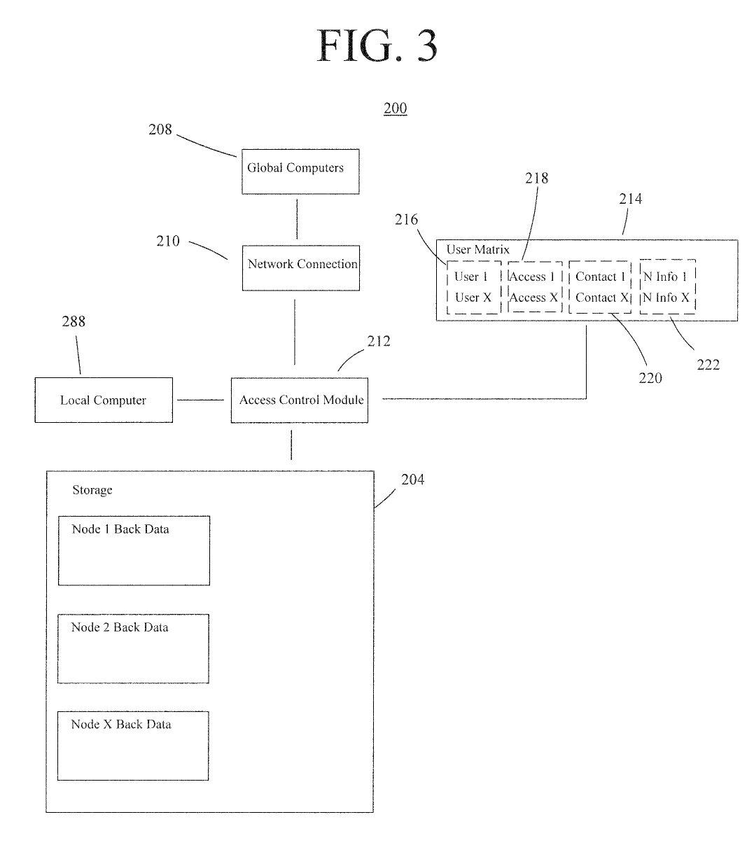

Turning now to FIGS. 1 and 3, the user access level may be determined 104 by an access control module 212. It is preferred that the present invention include a user matrix database 214 that includes multiple categories, including a user list 216, an access level 218, user contact 220, and other information categories 222 that may be desirable to associate with user access, control, notification, warnings, or other actions. The user list 216 includes a listing of personnel relevant to the business organization using the present invention. Relevant personnel may include officers, independent contractors, managers, employees, and the like. An access level includes instructions for the present invention that set access parameters of users as they relate to nodes. The access level 218 may include discrete clearances that correlate to a level value and permits access to nodes having a clearance value above, below, or equal to that level. The access level may include discrete node references that identify particular nodes to which a user may rightfully gain access. Any means of controlling user access may be used with the present invention. The user contact 220 category includes contact data associated with a user. Preferred contact data includes one or more electronic mail addresses. Association of electronic mail addresses with a user permits users to be contacted on the basis of additions, modifications, or deletions of data or documents from the present invention. The present invention may further include any other information that may be associated with one or more users and the present invention is not meant to be restricted to any particular forms of information.

Returning to FIGS. 1 and 2, the nodes 206 are presented to the user from a program comprising a user interface, i.e. front end, and a database, i.e. back end. The user interface executes commands and pulls data from the database. The preferred database utilizes an SQL server back end database, a MICROSOFT high end database that results in virtually no limitations on the number of users and/or the size of the database other than those imposed by the server/internet connection. The present invention preferably provides many levels of security used to help ensure the integrity of company data. The security can be broken down into three categories: physical, server, and program and data backups. Servers are located behind a dedicated CISCO firewall which protects client data from malicious internet attacks. The servers, i.e. the global computer, are located at a secure facility. The preferred facility is a tier-1 data center and features: a diesel generator; N+1 redundant HVAC system; anti-static environment; triple power feeds, UPS; N+1 cooling units; MGE UPS battery backup; 10 gigabit Ethernet core; all-switch-based internal network; 100% network uptime guarantee; current generation TERRATHON class routers with terrabit routing capacity; backbone connections from LEVEL 3, MCI, and TIME WARNER; over 300 direct private peering relationships to ensure optimal delivery of traffic; over 47 Gbps in total bandwidth capacity; and servers placed in a segmented network. Access to the network server is controlled via user accounts and passwords. User accounts are created and maintain by server administrators. Only designated users should have access to log in to the remote global server connection 210.

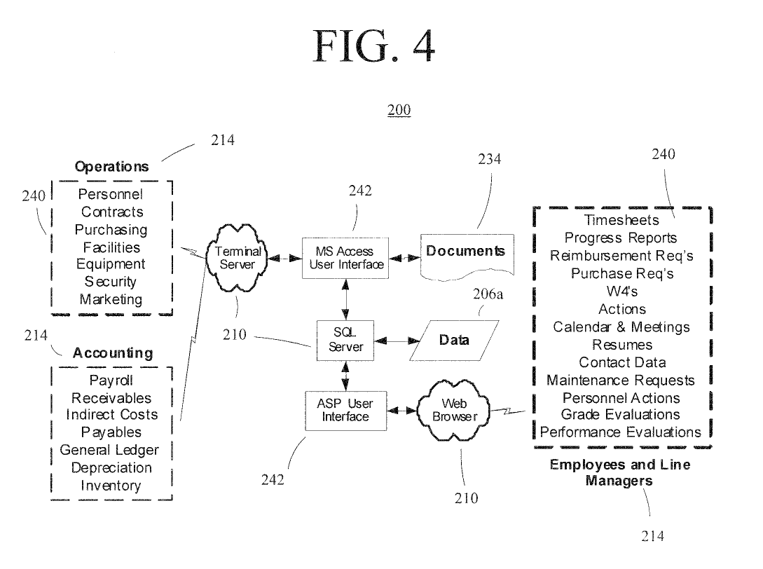

As FIG. 4 shows, it is preferred that there are two user interfaces 242. Both are accessible via the internet. The web browser interface 242, preferably constructed with Active Server Pages, is designed to provide tools for company employees/consultants, job managers, supervisors and division mangers. The tasks performed and reports viewed on this interface 242 tend to be high volume, i.e. many users, but low in complexity. The Manager Interface, accessed via a Terminal Server and constructed with MS Access, is designed to provide tools for company corporate managers, functional managers and accounting staff. The tasks performed and reports viewed via this interface tend to have fewer users than those of the web browser, but are more complex.

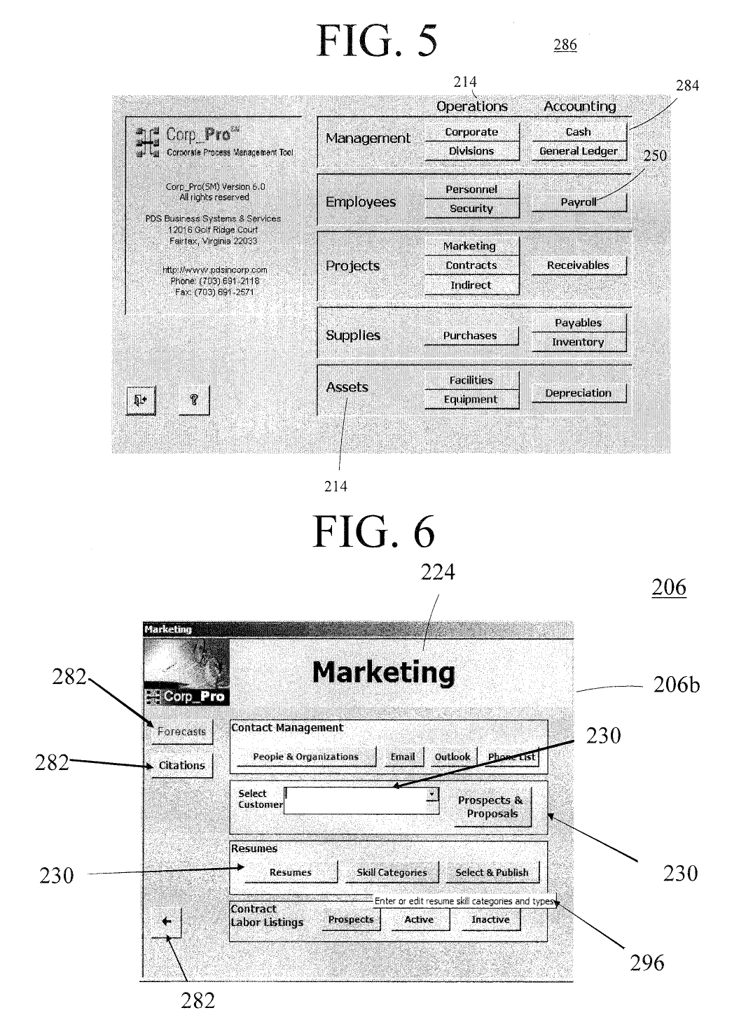

As shown in FIGS. 1, 4, 5, and 6, the interface 242 permits access to the nodes 206 that correspond to predefined subject matter subdivisions 240 within or relating to the company. It is preferred that all company responsibilities are addressed; the intent being that the present invention is the only accounting tool required and all company operations are integrated. New employees may automatically be assigned a user name and a default password when they are entered via a personnel node 206. Users can use the password to log onto the web or the terminal server interface. They can change the password there through an individual personnel node. Access to the present invention is controlled through the interfaces.

It is preferred to construct the security of the present invention according to at least two levels of security. The first is to the server. Users may be given a password and rights to log on to the folder in which their copy of the program of the present invention has been installed. The second is for the present invention itself. Privileges to the various nodes are assigned in a corporate node. An employee may be given privileges to as many nodes as desired. Each node on the terminal service interface contains tools need to perform its designated tasks. The nodes may be accessed through a node menu 286 that depicts nodes available or existing. Node depictions 284 portray node entry points, preferably defined by a node nominative descriptor 250, from which information, data, or more nodes may exist. Granting access to a node may grant privileges are for all functions/reports within the node, or access may be granted for portions of a node. Nodes, which naturally correlate to company category subdivisions 214 may be further arranged by relation to audit criteria divisions or other natural company segmentations.

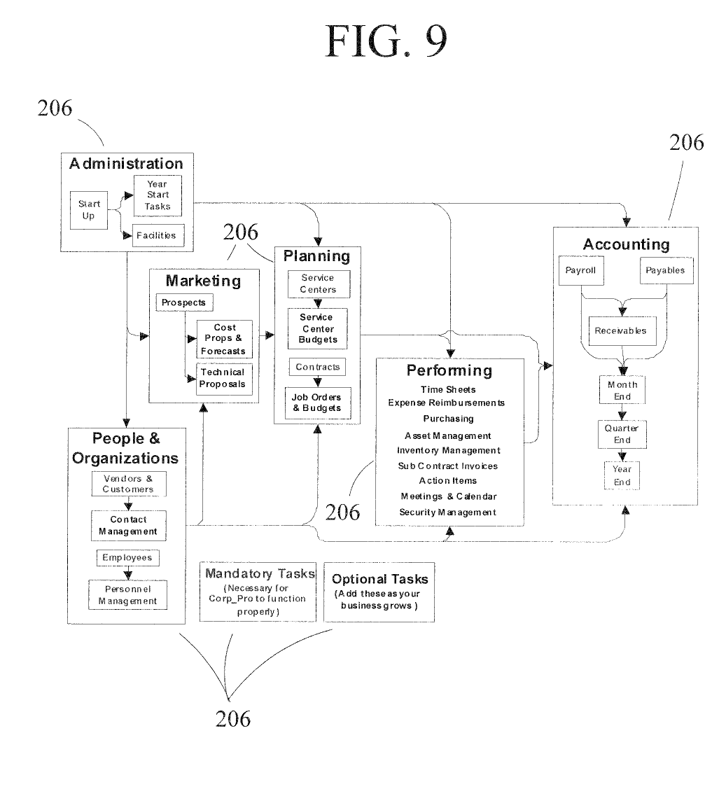

Returning to FIGS. 1, 2, and 6 the interface projects 102 the nodes 206 to the user. The nodes 206 act as subject-related data holders with a portion 206b visible to a user and a portion 206a that is electronically-readable data. The visible data, or node front descriptive data 206b, includes nominative data 224, node file descriptors 228, and node input descriptors 230 for the ordered input of substantive data. Node back data 206a, i.e., data electronically readable, includes the substantive data, which may be further classified as community data 238, input according to the node input descriptors 230. Each node 206 contains tools 282 (e.g., forms for entering data, reports for viewing data, and algorithms for processing data) for a functional area related to the particular subject of the node. Other tools 282 may exist purely for the purpose of simplified navigation or otherwise. The data entered via the various nodes is preferably deposited in a single, integrated, highly complex data lattice. This lattice has been designed to permit the data entered within a given nodes to be shared, as appropriate, by other modules. Data used by two or more nodes is referenced herein as community data 238. Performance according to the present invention permits a merging of accounting and financial reporting, which are products of, and benefit from, work performed in other processes. In like manner, project control benefits from project set up; project set up benefits from marketing; and so on, see e.g. FIG. 9.

The present invention is a relational database. Therefore, it may be configured such that substantive data must be entered before other substantive data can be entered or reviewed. A preferred sequence is illustrated in the figure FIG. 9. Specifically it is preferred that subject matter data nodes 206 related to ‘Administration’ are entered first, then subject matter nodes related to ‘People & Organizations’ and then set up other business duties and relationships such as contracts and service centers. The present invention may deem certain tasks within the present invention as mandatory and others as optional. The optional tasks are provided to assist a user in controlling/managing the organization as it grows (and you start having more employees/jobs to contend with).

The present invention is an accrual accounting system. However, data is tagged in the journals by many dates/times that mean different things. Periods are time slots to which transactions are assigned. The present invention recognizes three types of periods: accounting periods, pay periods, and tax periods. Transactions are preferably tagged with an accounting period; payroll transactions should also be assigned to a pay period and a tax period. The accounting period is the calendar month (Jan, Feb, etc) to which a transaction applies. The accounting period is the month the revenue was earned or the expense was incurred for accrual transactions. It is the month cash was deposited or withdrawn from the bank for cash transactions. There are two pay periods in each period. The first extends from the 1st until the 15th; the second from the 16th until the end of the month. Note that pay periods will have a different number of work days depending on the number of weekdays and holidays in the month. The payroll tax period is the quarter/year that applies to a payroll transaction for payroll tax purposes. This is generally the same as the quarter/year for the pay period except for the last period in each quarter.

Turning now to FIG. 6, the node 206 includes a node interface front 206b with node front descriptive data. The visible data, or node front descriptive data 206b, includes nominative data 224, node file descriptors (not shown), and node input descriptors 230 (shown as both the input descriptor and field) for the ordered input of substantive data. Furthermore, nodes may include ancillary function buttons 282 for data and communication functions such as report generators based on entered substantive data, transfer to foreign nodes, and the like. Example data capable of being accessed from the node front data includes Pivot Table Reports, Canned Reports, Data Entry Forms, Filters, Area Boxes, Pop Up Bubbles, Record Selectors, Referential Integrity Errors, User Entered Data, User Selected Values, and Invention Entered Data. Pivot Tables are a built in feature of MS Access. They are flexible, user defined, reports wherein the user is given choices of data fields and their use (rows, columns, filters, data) on the report. The results may be displayed in a graphic or tabular format. Canned reports are pre-fabricated reports, i.e the user cannot modify them. Data Entry Forms are for entering data. Filters include drop down combination boxes that permit users to select filter parameters for associated reports. Area boxes are used to group reports/forms with their associated filter drop down box. Pop up bubbles 296 appear over buttons/tabs/data fields and other controls to describe their purpose. Record selectors are at the bottom and side of forms. A Referential Integrity Error message will appear if you attempt to delete data from a record that is being used elsewhere in the system, i.e. community data (for example if you try to delete a customer to whom a contract has been assigned). User Entered Data includes fields that require data to be entered by the user. These fields are not required values (i.e. one may leave them blank or fill them as desired). Invention entered data includes fields with a transparent background contain data automatically entered by the system as community data or other predefined data (e.g. current postage rates).

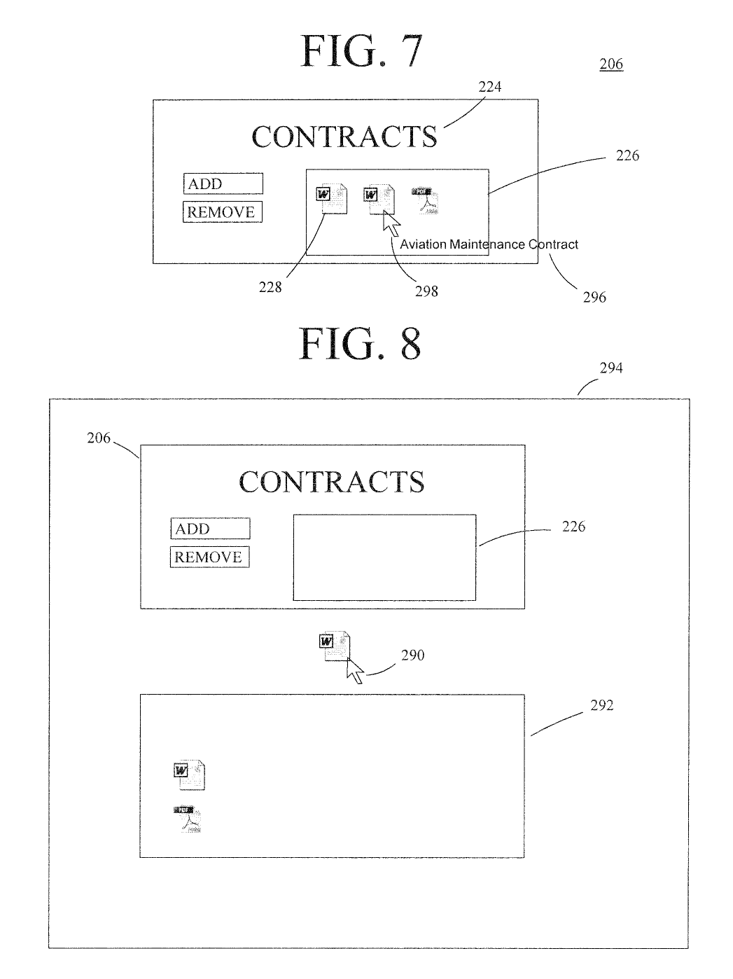

Turning now to FIGS. 1, 7, 8, and 10 the integrated document storage feature included with the present invention provides 108 a routine that permits the storage of documents online in native electronic format. By native format, it is meant that the document maintains the format characteristics of the program that created the document to the extent that it may still be read by that program. For example, a native format for MICROSOFT WORD may be .doc, .docx, or .pdf. Documents may be filed with the appropriate node 206 in the system for ease of location and convenience of retrieval. The location for filing a document associated with each process is depicted in the node front descriptive data for each node and may include a drop box 226, preferably a two-dimensional drop box with a defined periphery that permits a user to ‘drag-and-drop’ 290 files from a secondary program 292 into the defined periphery of the two-dimensional drop box. This permits a user to run a secondary program 292, e.g. e-mail program, web browser, etc., simultaneously with the present invention on the same screen 294 and permit simplified transfer. By filing 124 the document, the user may transfer the record file from the local storage by which the user is directly accessing the present invention to the global storage that permits access to multiple online users. At least two means of document storage may be utilized with the present invention, the document may be physically stored in storage 204 bearing the SQL database, or the document may be stored in accessible storage 204 distant from both the local computer and the storage bearing the SQL database and only the path to the document is present in the SQL database. Alternatively document storage may occur on the local computer being accessed, which may in turn be accessible to the local computer of others. The drop box 226 may include any means of computerized transfer 124 from one program to another, such as nested file search and transfer, as a WINDOWS EXPLORER or other file manager application would utilize. The native record document files may be static in use with the present invention in that the present invention does not have direct access to the record documents; instead, a secondary program, must be used to access and modify the record documents.

Substantive data includes data that derives from user input according to the parameters of node input descriptors. Preferred substantive data includes data that characterizes any company category division. Anytime that substantive data or record document files are added, modified, or removed from the present invention, the present invention may adjudge 120, 122 the applicability of the data or record document file to another, or “foreign,” user different from the user that input the data or another, or “foreign,” node different from the node that initially accepted the data. The foreign user may be notified 118 of the addition, modification, or removal and take action thereon. The foreign node may be updated 116, which includes alterations, modifications, additions, and removals, based on the entry of substantive data into the node before the user, the “local node,” during the data entry. Substantive data or record document files that may be pertinent to a foreign user or a foreign node are referred to as community data and community record document files.

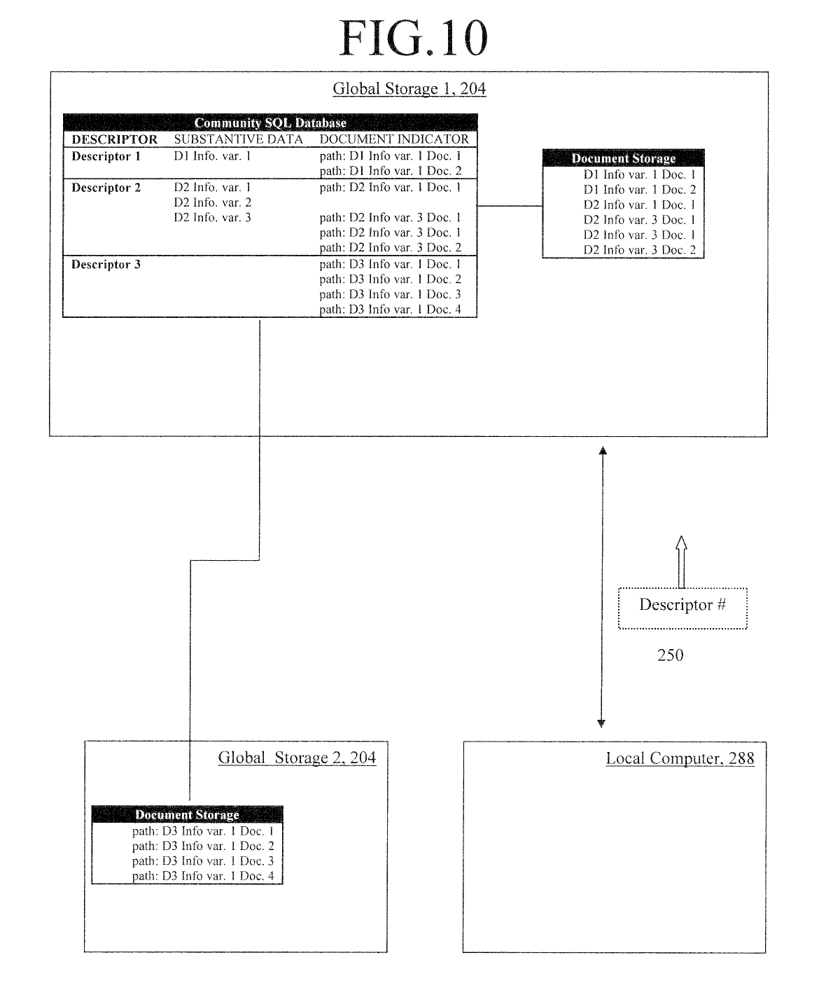

With specific reference to FIG. 10, the preferred data lattice that contains the community information of the present invention includes at least a three variable matrix: a descriptor, related substantive data, and document indicator. A user that accesses the present invention on a local computer may select a node having multiple record files. The record files are visible to the user on the local computer only as a file descriptor. The data lattice may be arranged in any fashion logical to pursue the advantages of the present invention. A preferred means of arranging the data of the present invention includes offering information on substantive data and document indicators upon selection of a node by the user. Upon recognition by the system that a user is in a particular node, the linked substantive data or document indicators associated therewith may be transmitted to the local computer. Furthermore, access to a particular set of substantive data may trigger a transfer of document indicators related thereto to the local computer.

Returning to FIGS. 1, 7, 8, and 10, the existence of one or more record documents is preferably indicated 110 by a file descriptor 228. The file descriptor 228 may be any means or symbol that conveys to the user that a record document is associated with a particular node 206. Preferred file indicators include pre-existing icons for the native format. Furthermore, the file descriptor 228 may include the name of the file as a popup 296 or other means of conveying alpha-numeric data.

The drop box may be utilized for any company subject subdivision and node. For example, employee documents (offer letters, check stubs, etc.) may be filed in the Personnel Node with each applicable employee. Permissions in the system automatically serve to ensure that the correct personnel have access to the documents. Meanwhile, the on line nature provides accessibility regardless of geographical location. When the drop box is utilized, it is preferred that the present invention request from the user and retain 112 substantive data related to the record file document thus accepted. Optical character recognition may be used with the present invention to retain substantive data related to the record document file, but it is preferred that the present invention merely request manual entry of data related to the document of the record document file.

Due to the nature of the global storage 204 and network connection 210 of the present invention, data and record file documents applied thereto may be displayed 114 to users of the present invention in contemporaneous to the time of entry and submission.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A virtual electronic ledger for sharing and locating business documents among multiple users via a computer system, said ledger comprising:
a local computer with a local storage;
a global computer, in electronic communication with said local computer, with global storage;
a community database, stored on said global storage, having a community index that bears entered community substantive data linked with a community document indicator that describes a distinct file path for a community document informationally related to said linked community substantive data; and
multiple subject nodes, stored on said global storage and accessible from said local computer, each of said subject nodes conforming to one of predefined company category subdivisions and comprising:
node front descriptive data, visible to the user on said local computer, having: a node nominative descriptor conforming to said distinct predefined company category subdivision of said node, a node community file descriptor informationally linked to said community document indicator, and a node input descriptor adapted to solicit said substantive community data for unidirectional transmission of substantive community data to said community database; and
node back data bearing a node community data link to said community index for exchanging community substantive data with said community database; and a two-dimensional node drop box, visible to the user, adapted to accept native, static record document files, related to said one of predefined company category subdivisions, from said local storage for transmission to and retention on said global storage as one of said community documents.

2. The ledger of claim 1 further comprising a user matrix, accessible from said storage, having a user list correlated to a node permission Boolean list.

3. The ledger of claim 2 wherein said user matrix further includes a user contact list adapted to communicate a node data alteration to the users according to said user list and said node permission Boolean list.

4. The ledger of claim 1 wherein said global storage includes a partitioned, segregated global storage and wherein said community database resides on a first partition of said global storage and at least one community document is stored on a second partition of said global storage.

5. The ledger of claim 1 wherein said global storage includes a partitioned, segregated global storage and wherein said community database resides on a first partition of said global storage and at least one community document is stored on a second partition of said global storage.

6. The ledger of claim 1 wherein said community database includes an SQL database having the following attributes: descriptor, substantive data, and document indicator; and wherein said document indicator includes a path to a native document file.

7. The ledger of claim 1 wherein said community database includes an SQL database having the following attributes: descriptor, substantive data, and document indicator storing a native document file with said SQL database.

8. A method for automatic paperless maintenance of documents relating to predefined business transaction subject categories using a computer system, said method comprising:
initializing through an interface multiple subject nodes, from a global computer to multiple local computers each having informational access to said global computer, wherein said subject nodes correspond to individual business transaction subject categories and include:
a node nominative descriptor for indicating one of said transaction subject categories,
a node file descriptor for indicating a category of record, and
a node input descriptor for indicating a category of allowed transaction actions;
providing to a user upon accessing a subject node: a node drop box, visible to the user within said interface, adapted to accept native, static record document files associated with said nominative descriptor of said accessed subject node; and said node input descriptor of subject node;
transferring said record document files from a local storage of said local computer to a global storage of said global computer that retains said record document file;
retaining substantive data, input by a user through said node input descriptor, related to said record document file associated with said accessed subject node; and
indicating to the user through said interface, projected from said global computer to said local computer through at least one of said subject nodes, accepted record document files with said node file descriptor.

9. The method of claim 8 further comprising defining a user matrix having a user list correlated to a node permission Boolean list

10. The method of claim 9 further comprising reviewing said substantive data based on a user-specific clearance level derived from said node permission Boolean list.

11. The method of claim 10 further comprising communicating said substantive data as community substantive data to at least one foreign node.

12. The method of claim 11 further comprising:
updating said substantive data of said node; and
notifying a foreign user of said update.

13. The method of claim 12 wherein said notifying includes notifying said foreign user based on said user-specific clearance level derived from said node permission Boolean list.

14. The method of claim 8 further comprising correlating said multiple subject nodes to a standard list of audit compliance subjects.

15. The method of claim 14 further comprising correlating said multiple subject nodes to a standard list of audit compliance subjects as a 1:1 match.

16. The method of claim 14 further comprising communicating said substantive data as community substantive data to at least one foreign node.

17. The method of claim 16 further comprising the method of claim 8 further comprising defining a user matrix having a user list correlated to a node permission Boolean list

18. The method of claim 17 further comprising reviewing said substantive data based on a user-specific clearance level derived from said node permission Boolean list.

19. The method of claim 18 further comprising communicating said substantive data as community substantive data to at least one foreign node.

20. The method of claim 19 further comprising:
updating said substantive data of said node; and
notifying said foreign user based on said user-specific clearance level derived from said node permission Boolean list.

21. A method for automatic paperless maintenance of documents relating to predefined business transaction subject categories using a computer system, said method comprising:
initializing through an interface multiple subject nodes, from a global computer to multiple local computers each having informational access said global computer, that correspond to individual business transaction subject categories, wherein said subject nodes including:
a node nominative descriptor for indicating a category of transaction,
a node file descriptor for indicating a category of record, and
a node input descriptor for indicating a category of allowed transaction actions;
providing to a user upon accessing one of said subject nodes: a node drop box, visible to the user within said interface, adapted to accept native, static record document files associated with said nominative descriptor of said accessed subject node;
transferring said record document files from a local storage of said local computer to a global storage of said global computer that retains said record document file;
retaining substantive data, input by a user through said node input descriptor, related to said record document file associated with said accessed subject node;
communicating said substantive data as community substantive data to at least one foreign node so as to update said substantive data of said foreign node to mirror the substantive data of said node from which said substantive data was input; and
indicating to the user through said interface, projected from said global computer to said local computer through at least one of said subject nodes, accepted record document files with said node file descriptor.
